(19) United States
(12) Patent Application Publication
(10) Pub. No.: US 2013/0123976 A1
(43) Pub. Date: May 16, 2013

(54) Method and Apparatus for Fulfilling an Offer

(71) Applicants: Guerin James McClure, Cincinnati, OH (US); Franklin Flurry, Prairie Grove, AR (US); Austin Hobbs, Rogers, AR (US); Jason Stewart, Fayetteville, AR (US); Rendall Koski, New York, NY (US); Kirk Vlastakis, Clemmons, NC (US); Chris Kirk, Kernersville, NC (US); Kien Lao, Durham, NC (US); Chris Church, Durham, NC (US); David Rankin, Winston Salem, NC (US); Stephen Cukiernik, Winston Salem, NC (US); Greg Tetrualt, Winston Salem, NC (US)

(72) Inventors: Guerin James McClure, Cincinnati, OH (US); Franklin Flurry, Prairie Grove, AR (US); Austin Hobbs, Rogers, AR (US); Jason Stewart, Fayetteville, AR (US); Rendall Koski, New York, NY (US); Kirk Vlastakis, Clemmons, NC (US); Chris Kirk, Kernersville, NC (US); Kien Lao, Durham, NC (US); Chris Church, Durham, NC (US); David Rankin, Winston Salem, NC (US); Stephen Cukiernik, Winston Salem, NC (US); Greg Tetrualt, Winston Salem, NC (US)

(21) Appl. No.: 13/535,395

(22) Filed: Jun. 28, 2012

Related U.S. Application Data
(60) Provisional application No. 61/503,021, filed on Jun. 30, 2011.

(51) Int. Cl. G06F 17/00

(52) U.S. Cl. CPC G06F 17/00
USPC 700/237

(57) ABSTRACT

A method and apparatus for fulfilling a product offer are described herein. An offer of a product sample is made in exchange for a shopper checking in at a vending machine on asocial networking site. Information associated with a check-in is passed to a vending machine which dispenses a product sample.

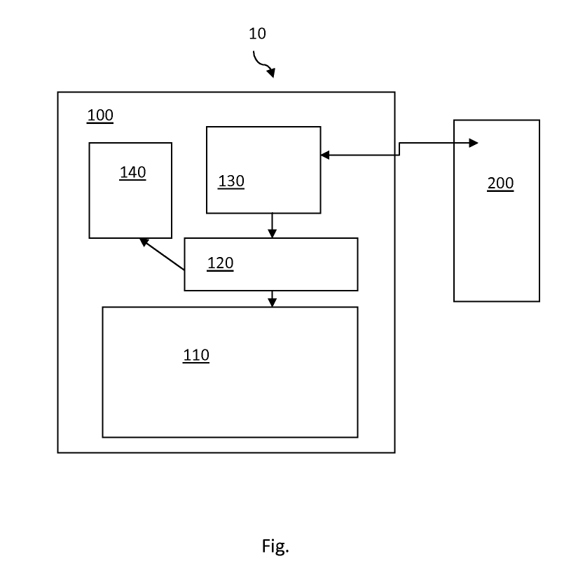

### CROSS REFERENCE TO RELATED APPLICATIONS

This application claims the benefit of U.S. Provisional Application No. 61/503,021, filed Jun. 30, 2011.

### FIELD OF THE INVENTION

The invention elates to the field of fulfilling a product offer. The invention relates particularly to the field of fulfilling a product offer via a network and a local vending machine.

### BACKGROUND OF THE INVENTION

Thousands of new consumer products are introduced each year. When a new product is introduced into a consumer market, the manufacturer and retailer face the challenge of informing potential consumers of the existence and functionality of the product.

Providing consumers with free or low cost single use samples of new products as a way of introducing these potential users to the product is well known in the art. Mass mailings of samples to either targeted audiences, where a demographic profile associated with the audience members matches a target market demographic of the new product, as well as blind mailings where samples are simply sent to all residents in a particular geography are well known. Including a means for the recipient of the sample to provide feedback to the manufacturer with the sample is also well known. Also well known are in-store sample offers where shoppers are provided with a product sample in the retail environment where there is also an opportunity to purchase more of the product.

These sample offering methods yield a localized impact by providing individual consumers with product samples. Providing samples to all members of a target market segment at the introduction of a new product in order to raise awareness and drive trial use of the product may be cost prohibitive and/or may require significant logistics resources to product and distribute the sample products. What is needed is a way to increase the impact each offered sample has in the target market segment beyond the individual consumer provided with the sample.

### SUMMARY OF THE INVENTION

A method and apparatus for fulfilling a product offer are described herein. The method and apparatus leverage telecommunications-based social networks of participating consumers to increase the impact of each sample. By utilizing the existing social networks of the participants, the market awareness achieved by fulfilling each product sample offer may be increased. The use of existing social networks to spread knowledge of the new product also provides a separate avenue for target consumers to become aware of the new product. Direct marketing efforts by the manufacturer and retailer may be augmented by communications from members of an individual's social network.

In one aspect, the invention comprises a method for fulfilling a product sample offer. The method comprises steps of: providing an automated product sample vending apparatus comprising a telecommunications link and adapted to vend product samples upon command; offering individuals a product sample in exchange for a specified action by the individual; providing a virtual location where the individuals may complete the specified action; maintaining an incremental count of the number of completed specified actions; utilizing the telecommunications link to communicate to the vending apparatus that the incremental count has increased by one completed specified action; commanding the vending apparatus to vend one product sample; and vending one product sample.

In another aspect, a system for fulfilling a product sample offer comprises an apparatus. The apparatus comprises: a vending element, a communications element and a control element. The vending element comprises at least one product sample holding element. The sample holding element is adapted to dispense a product sample upon command. The communications element comprises at least one telecommunications link The control element is adapted to command the vending element to dispense a product sample in association with the receipt of information via the telecommunications link

### BRIEF DESCRIPTION OF THE DRAWINGS

The FIGURE provides a schematic illustration of the elements of a fulfillment system according to one embodiment of the invention.

### DETAILED DESCRIPTION OF THE INVENTION

As used herein, a telecommunications supported social network refers to any one a multitude of social networks which utilize computers, software and telecommunications networks to link the respective network members. Exemplary telecommunications supported social networks include without limitation: Foursquare™, Facebook™, LinkedIn™, OnlyMeWorld™, Google+™, Mylife™, and Myspace™.

As used herein the term providing as it relates to an activity includes direct action by an entity as well as indirect action through another party such as having another party provide the indicated good or service.

A method and apparatus for the fulfillment of product sample offers. The method includes providing an automated product sample vending apparatus comprising a telecommunications link and adapted to vend product samples upon command. The vending apparatus may comprise a typical vending system as is known in the art as far as the electro-mechanical portions of the machine responsible for holding and dispensing product samples. Exemplary vending machines include beverage vending machine, snack vending machines, personal care vending machines. In one embodiment the vending machine is augmented by the addition of at least one telecommunications element adapted to link the vending apparatus to a network. The at least one telecommunications link may comprise a TCPIP or other communications format based internet connection, a telephone connection, an sms messaging capability or a combination of these links In one embodiment the vending apparatus further comprises a display element. Exemplary display elements include without limitation liquid crystal displays, light emitting diode displays, eink displays, and cathode ray tube displays as such displays are known in the art. In one embodiment the vending apparatus comprises a laser based bar code reader. Such laser based bar code readers are available from SSE Technologies of Elmont, N.Y. The vending apparatus further comprises a control element adapted to command the vending element and to control the dispensing of product samples by the vending element. Exemplary control elements include: an Allen Bradley Micro-Logix model 1100 controller, available from Allen Bradley, Inc., of Milwaukee, Wis. The control element may also interface with and control the display element and the bar code scanner. The vending apparatus further comprises power supply elements to provide electrical power to the vending, communications, control and optional display and bar code scanning elements. The vending apparatus may also comprise decorative artwork in the form of printed text and/or graphics arrayed upon the various exposed surfaces of the apparatus.

The vending apparatus may be disposed at a retail location or any space where target consumers may be present. A public space, a sports venue or other such space. In one embodiment the vending apparatus may be disposed at a retail location. Beyond that the vending apparatus may be disposed at any location within the retail location wherein electrical power may be supplied to the apparatus. Alternatively, the apparatus may be powered utilizing a portable electrical generator or batteries. The vending apparatus may be disposed in a portion of the retail location associated with the category within which the product sample may be found, a category having a market adjacency to that of the product sample or an alternative location selected upon the basis of the typical traffic flow of shoppers at the location in order to increase the exposure of the vending apparatus and associated visible offers to shoppers visiting the location.

Product sample offers may be made via email, text messages, print or electronically transmitted media (television, radio, the internet, etc.) In one embodiment the offer may be made via artwork displayed upon a visible surface of the vending apparatus. The sample offer may call individuals to complete a specified action in order to qualify for the receipt of a product sample. The call to action may include the individual utilizing a telecommunications supported social network such as Facebook™, Foursquare™, or other such network systems, may require the individual to present themselves at a particular location, and to concurrently provide objective data associated with their presence to the utilized social network.

The call to action may require the individual to proceed to a check-in page from the landing page of the social network site or the offer may require the individual to proceed to a page associated with a brand associated with the product sample for the purpose of checking in there.

In one embodiment, to accept the offer of a product sample the individual may be asked to proceed to an apparatus located at a retail location, log in to a pre-existing or newly created telecommunications supported social network account such as Facebook™ and provide their geographic location to a pre-determined virtual location, a social network location, such as a Facebook™ page using GPS, WiFi, or other locating data provided via the individual's smart phone or other network connected device.

Upon the successful completion of this request, the individual may receive a product sample via an automated vending apparatus. The social network location may communicate directly with the vending apparatus or may communicate to a file server which may in turn communicate with the vending apparatus. In one embodiment the social network location may count the number of individuals who have successfully accepted the offer and may maintain an incremental counter reflecting that number. The current value of the counter may be provided to the vending apparatus or intermediary server as the counter increments or the value may be maintained and provided to the vending apparatus on an as requested basis in response to a query from the apparatus.

In one embodiment the apparatus may query the counter value and upon receipt of the response may compare the received value with a stored value. As or after this comparison indicates that the received value exceeds the stored value, the control element of the apparatus may command the apparatus to vend a sample and the stored value may be updated and set equal to the received value. In this embodiment, the vending apparatus may periodically query or ping the intermediary server or the social network location to determine the value f the counter. In one embodiment the social network may simply pass along information indicating that another individual has checked in successfully at the vending apparatus location to the vending apparatus or intermediary server. In this embodiment, the apparatus may dispense a sample upon notification of the additional checkin.

In one embodiment the social network server may track user checkins at the site as requested in the offer. The intermediary server may query the social network site for information relating to check-ins and may note that additional check-ins for a particular vending apparatus location have occurred since the last query associated with that location. The intermediary server may then increment a counter associated with the location and request an sms message be prepared and sent to the vending apparatus at that location.

In association with the successful fulfillment of the accepted offer, information associated with the social network profile or membership of the individual may be updated in association with the successful fulfillment of the accepted product sample offer. In one embodiment the individual's wall may be updated to reflect the location checkin they have performed and the fact that they have received a product sample in exchange for checking in at the vending apparatus.

In this embodiment, the fulfillment of the offer occurs without any communication between the individual and the vending apparatus. The individual communicates with a social network, the social network communicates with the vending apparatus or an intermediary file server which subsequently communicates with the vending apparatus and the vending apparatus dispenses a product sample which is collected by the individual located proximally to the vending apparatus. The social network need not pass personally identifiable information (PII) associated with the individual to the vending apparatus to complete the transaction.

In one embodiment, the social network may collect PII associated with the individual and may pass this information along such that the vending apparatus is provided with the identity of the individual, or with other information associated with the social network profile of the individual including browsing history, product interests, or product category interests derived from a browsing history. In this embodiment the vending apparatus may be provided with information sufficient to enable the selection and display of advertising or other product information tailored to appeal to the particular individual. In one embodiment, the selection and targeting may occur at the social network location or at an intermediary server or a third party ad selection server and may subsequently be provided to the vending apparatus via a telecommunications link. In one embodiment, the individual may be contacted by the manufacturer of the product subsequent to the fulfillment of the offer and afforded an opportunity to comment upon the product or other aspects of the product sample offer experience. This contact may be facilitated using contact information associated with the social network membership the individual used to accept the offer.

The communications element may comprise a link enabling the apparatus to send communications out to a server. The external server may be the intermediary server associated with the social networking site or may comprise a distinct server not associated with the social networking site. The apparatus may send communications or respond to queries from the external server relating to apparatus product sample inventory levels, and/or the current status of the apparatus with regard to its ability to dispense a product sample upon command. In this manner, the performance of one or more vending machine may be managed to avoid out of stock occurrences as well as reducing the amount of time any particular apparatus is unable to dispense product samples due to a machine malfunction such as a dispensing mechanism jam.

### EXAMPLES

In one embodiment a Merchant Four vending machine, available from Crane Merchandising Systems, of Bridgeton, Mo., equipped with an Allen Bradley Micro-Logix model 1100 programmable logic controller, available from Allen Bradley, Inc., of Milwaukee, Wis., a BUG custom hardware controller and usb interface available from BUG Labs, of New York, N.Y., and also including a 3G cellular card available from Sierra Wireless of Richmond, British Columbia, Canada, may be placed in a retail location. The machine may contain a plurality of product samples available to be dispensed. The machine may include artwork offering shoppers a free product sample if they check-in at a Facebook™ website. Additional offers may be made via other media including television, radio, and the internet. When shoppers physically located at the vending machine check-in via their personal smart phone they will find the location of the vending machine and check-in at the site. As location information from their smart phone coincides with the location of the vending machine they will be allowed to check-in at the machine. The website will track the number of check-ins and will update the profile of the shoppers who have checked-in. A Rackspace™ server, available from Rackspace, Inc, of San Antonio, Tex., will ping the Facebook™, site about once per second to determine if additional check-ins for the vending machine have occurred. If check-ins have occurred, the Rackspace™ server will order an sms message be sent to the telephone number associated with the vending machine 3G cellular card. Upon receipt of the proper sms message, the vending machine will dispense a product sample for collection by the shopper.

In one embodiment as shown in the FIGURE, an apparatus 100 comprises a vending element 110 linked to a control element 120. The control element 120 is also in communication with a communications element 130 and a display element 140. The communications element 130 has a telecommunications link with server 200.

In an alternative embodiment (not shown) the server may comprise a portion of the apparatus and may be in direct communications with the control element and may be linked to the social network via the communications element.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for fulfilling a product sample offer, the method comprising steps of:
a. providing an automated product sample vending apparatus, the apparatus comprising: a telecommunications link and adapted to vend product samples upon command;
b. offering individuals a product sample in exchange for a specified action by the individual;
c. providing a virtual location where the individuals may complete the specified action;
d. commanding the vending apparatus to vend one product sample; and
e. vending one product sample.

2. The method according to claim 1 further comprising the step of disposing the automated vending apparatus at a retail location.

3. The method according to claim 2 further comprising the step of disposing the automated vending apparatus in a portion of the retail location associated with the product category of the product sample.

4. The method according to claim 2 further comprising the step of disposing the automated vending apparatus in the retail location according to shopper traffic flow.

5. The method according to claim 1 wherein the offer is made via a telecommunications network.

6. The method according to claim 1 wherein the specified action includes a requirement to proceed to the location of the automated vending apparatus.

7. The method according to claim 1 further comprising steps of:
a. maintaining an incremental count of the number of completed specified actions;
b. utilizing the telecommunications link to communicate to the vending apparatus that the incremental count has increased by one completed specified action.

8. The method according to claim 1 further comprising the step of updating a profile associated with an individual as or after that individual completes the specified task.

9. The method according to claim 1 wherein the automated vending apparatus further comprises a display element and further comprising the step of displaying information tailored to appeal to an individual receiving a product sample.

10. A system for fulfilling a product sample offer comprising:
a. a vending element;
b. a communications element; and
c. a control element;
wherein: the vending element comprises at least one product sample holding element adapted to dispense a product sample upon command; the communications element comprises at least one telecommunications link The control element is adapted to command the vending element to dispense a product sample in association with the receipt of information via the telecommunications link.

11. The system according to claim 10, wherein the vending element further comprises a display.

12. The system according to claim 10, wherein the vending element further comprises a bar code scanner.

13. The system according to claim 10, wherein the vending element further comprises decorative artwork.
